(19) United States
(12) Patent Application Publication
(10) Pub. No.: US 2025/0293312 A1
(43) Pub. Date: Sep. 18, 2025

(54) NONAQUEOUS ELECTROLYTE SECONDARY BATTERY

(71) Applicant: Prime Planet Energy & Solutions, Inc., Tokyo (JP)

(72) Inventor: Harunari SHIMAMURA, Toyonaka-shi (JP)

(21) Appl. No.: 19/077,060

(22) Filed: Mar. 12, 2025

(30) Foreign Application Priority Data
Mar. 14, 2024 (JP) 2024-040439

(51) Int. Cl. H01M 10/0585; H01M 10/0525; H01M 50/342

(52) U.S. Cl. CPC H01M 10/0585; H01M 10/0525; H01M 50/3425

(57) ABSTRACT

The present disclosure provides a nonaqueous electrolyte secondary battery including a multilayer electrode body and a battery case. The battery case includes a lower surface, and the lower surface includes a gas exhaust valve. The multilayer electrode body includes a pair of flat surfaces, and a lower end surface and an upper end surface. A tape is attached to the multilayer electrode body so as to link between the pair of flat surfaces. The lower end surface and the upper end surface of the multilayer electrode body are covered with the tape asymmetrically.

### CROSS REFERENCE TO RELATED APPLICATION

This application claims the benefit of priority to Japanese Patent Application No. 2024-040439 filed on Mar. 14, 2024. The entire contents of this application are hereby incorporated herein by reference.

### BACKGROUND OF THE DISCLOSURE

### 1. Field

The present disclosure relates to a nonaqueous electrolyte secondary battery.

### 2. Background

A nonaqueous electrolyte secondary battery including a multilayer electrode body, a nonaqueous electrolyte, and a battery case that accommodates the multilayer electrode body and the nonaqueous electrolyte has conventionally been known. Conventional technical literatures related to such nonaqueous electrolyte secondary batteries include Japanese Patent Application Publication No. 2008-91099, Japanese Patent Application Publication No. 2016-194979, and WO 2017/033420. For example, according to Japanese Patent Application Publication No. 2008-91099, displacement in stacking is suppressed by attaching a displacement preventing tape to a multilayer electrode body.

### SUMMARY

According to the present inventor's examination, when the temperature increases due to overcharging or the like, a nonaqueous electrolyte is decomposed in a battery to generate gas in some cases. Therefore, when the pressure in the battery becomes a predetermined value or more, an unexpected part of the battery case may be cleaved, in which case the content of the battery (for example, a fragment of an active material layer or the like) may be discharged from the cleaved part to the outside and scatter to the periphery.

The present disclosure has been made in view of the above circumstances, and an object is to provide a nonaqueous electrolyte secondary battery in which an unexpected part of a battery case is not easily cleaved.

A nonaqueous electrolyte secondary battery according to the present disclosure includes a multilayer electrode body that includes a plurality of positive electrodes and a plurality of negative electrodes, a nonaqueous electrolyte, and a battery case that accommodates the multilayer electrode body and the nonaqueous electrolyte. The battery case includes at least a lower surface, a pair of side surfaces extending from a pair of edges of the lower surface and facing each other, and an upper surface facing the lower surface, a gas exhaust valve is provided at the lower surface, the multilayer electrode body includes a pair of flat surfaces facing the pair of side surfaces of the battery case, and a lower end surface facing the lower surface of the battery case and an upper end surface facing the upper surface of the battery case, the lower end surface and the upper end surface being end surfaces where a multilayer structure of the positive electrodes and the negative electrodes is exposed, at least one tape is attached to the multilayer electrode body so as to link between the pair of flat surfaces, and the lower end surface and the upper end surface of the multilayer electrode body are covered with the tape asymmetrically so that gas flows toward the gas exhaust valve.

According to the present disclosure, the gas generated in the battery is easily exhausted to the outside stably from the gas exhaust valve provided at the lower surface of the battery case. Accordingly, the cleavage of an unexpected part of the battery case can be suppressed.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating a nonaqueous electrolyte secondary battery according to one embodiment;

FIG. 2 is a perspective view in which the nonaqueous electrolyte secondary battery in FIG. 1 is inverted in an up-down direction;

FIG. 3 is a schematic longitudinal cross-sectional view taken along line III-III in FIG. 1;

FIGS. 4A to 4C are schematic plan views illustrating modifications of a gas exhaust valve;

FIG. 5 is a perspective view schematically illustrating a multilayer electrode body in FIG. 3;

FIG. 6 is a perspective view schematically illustrating the flow of gas in the multilayer electrode body in FIG. 5;

FIGS. 7A and 7B are diagrams corresponding to FIG. 6 according to Comparative Examples 1 and 2;

FIGS. 8A to 8C are diagrams corresponding to FIG. 6 according to Comparative Examples 3-1 to 3-3;

FIGS. 9A and 9B are diagrams corresponding to FIG. 6 according to Examples 2-1 and 2-2;

FIGS. 10A and 10B are diagrams corresponding to FIG. 6 according to Examples 3-1 and 3-2;

FIGS. 11A and 11B are diagrams corresponding to FIG. 6 according to Examples 4-1 and 4-2;

FIG. 12 is a diagram corresponding to FIG. 6 according to Example 6;

FIGS. 13A and 13B are diagrams corresponding to FIG. 6 according to Examples 7-1 and 7-2;

FIGS. 14A and 14B are diagrams corresponding to FIG. 6 according to Examples 8-1 and 8-2;

FIGS. 15A and 15B are diagrams corresponding to FIG. 6 according to Examples 9, 10, and 11; and

FIGS. 16A and 16B are diagrams corresponding to FIG. 6 according to Examples 12 and 13.

### DETAILED DESCRIPTION OF THE PREFERRED EMBODIMENTS

Some embodiments of the art disclosed herein will hereinafter be described in detail with reference to the drawings. Matters that are other than matters particularly mentioned in the present specification and that are necessary for the implementation of the art disclosed herein (for example, the general configuration and manufacturing process of a nonaqueous electrolyte secondary battery that do not characterize the art disclosed herein) can be grasped as design matters of those skilled in the art based on the prior art in the relevant field. The art disclosed herein can be implemented on the basis of the contents disclosed in the present specification and common technical knowledge in the relevant field. Note that in the drawings below, the members and parts with the same operation are explained by being denoted by the same reference sign.

In the present specification, “nonaqueous electrolyte secondary battery” refers to a general electrical energy storage device capable of being repeatedly charged and discharged by transfer of charge carriers between a positive electrode and a negative electrode through a nonaqueous electrolyte. In the present specification, the notation “A to B” for a range signifies a value more than or equal to A and less than or equal to B, and is meant to encompass also the meaning of being “more than A” and “less than B”.

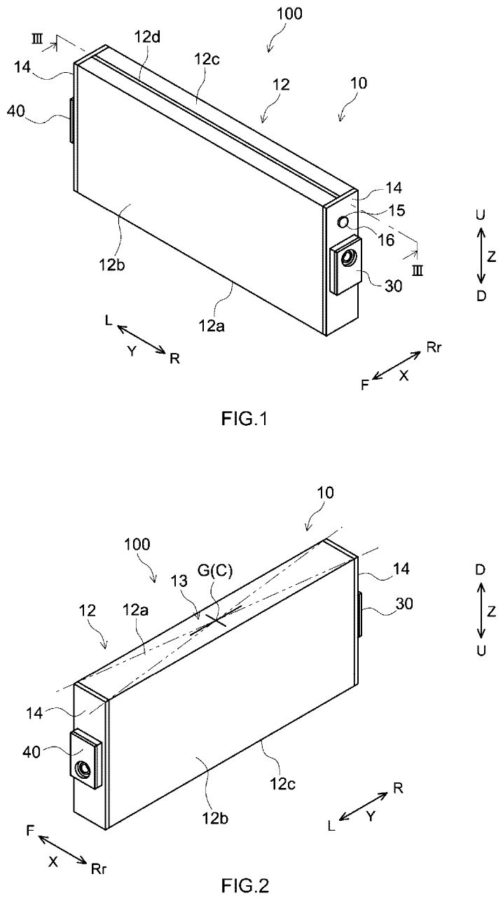

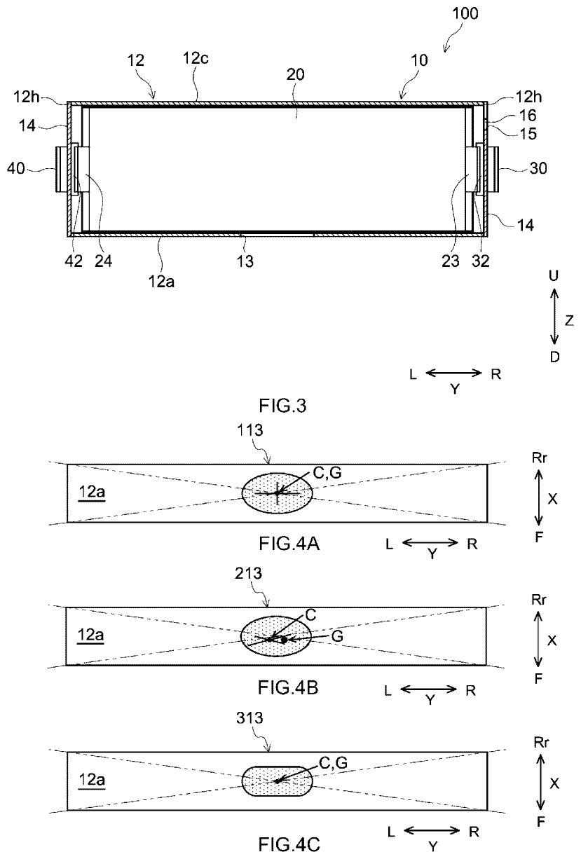

FIG. 1 is a perspective view of a nonaqueous electrolyte secondary battery (hereinafter, also referred to as “battery” simply) 100 according to one embodiment. FIG. 2 is a perspective view in which the battery 100 in FIG. 1 is inverted in an up-down direction. FIG. 3 is a schematic longitudinal cross-sectional view of the battery 100 taken along line III-III in FIG. 1, and illustrates an internal structure thereof. In the following description, reference signs L, R, F, Rr, U, and D in the drawings respectively denote left, right, front, rear, up, and down, and reference signs X, Y, and Z in the drawings respectively denote a thickness direction of the battery 100, a width direction that is orthogonal to the thickness direction, and an up-down direction that is orthogonal to the thickness direction and the width direction. The up-down direction Z is typically a vertical direction.

For example, the battery 100 is mounted on a vehicle or the like in a direction illustrated in FIG. 1. Here, the battery 100 is a square battery that has a square shape including a hexahedron (in detail, rectangular parallelepiped shape). As illustrated in FIG. 3, the battery 100 includes a battery case 10, a multilayer electrode body 20, a nonaqueous electrolyte solution (not illustrated), a positive electrode terminal 30, and a negative electrode terminal 40. The nonaqueous electrolyte solution is one example of a nonaqueous electrolyte. The battery 100 is a lithium ion secondary battery here.

The battery case 10 is a housing that accommodates the multilayer electrode body 20 and the nonaqueous electrolyte solution. As illustrated in FIG. 1 and FIG. 2, the battery case 10 has an outer shape that is a flat bottomed cuboid shape (square shape) here. The material of the battery case 10 may be similar to the conventionally used material without particular limitations. The battery case 10 is preferably made of metal, and more preferably aluminum, an aluminum alloy, iron, an iron alloy, or the like, for example.

As illustrated FIG. 3, the battery case 10 includes a case main body 12 having a pair of openings 12h at both end parts in the width direction Y, and two sealing plates 14 that cover the pair of openings 12h of the case main body 12 here. The battery case 10 is integrated in such a way that the sealing plates 14 are bonded (for example, bonded by welding) to peripheral edges of the pair of openings 12h of the case main body 12. The battery case 10 is hermetically sealed (closed).

The case main body 12 has a rectangular cylindrical shape, and as illustrated in FIG. 1, includes a lower surface 12a with an approximately rectangular shape having long sides and short sides, a pair of long side surfaces 12b facing each other and extending from the pair of long sides (edges) of the lower surface 12a that face each other, and an upper surface 12c facing the lower surface 12a. The long side surface 12b is larger in area than the lower surface 12a and the upper surface 12c. The upper surface 12c has an approximately rectangular shape similarly to the lower surface 12a. The upper surface 12c connects upper end parts of the pair of long side surfaces 12b. The case main body 12 is formed by, for example, bending one sheet of metal plate into a tubular shape and bonding (for example, bonding by welding) a joint. Here, a welding bonding part 12d is provided on the upper surface 12c.

As illustrated in FIG. 2, the lower surface 12a includes a gas exhaust valve 13. The gas exhaust valve 13 is configured to fracture when pressure inside the battery case 10 reaches a predetermined value or more and discharge a gas in the battery case 10 to the outside. The lower surface 12a is a surface to be in contact with a frame body of a module or a pack (typically, made of metal), and releases the heat easily. Thus, when the gas exhaust valve 13 is provided at the lower surface 12a, the gas generated in the battery case 10 is brought into contact with the lower surface 12a and is cooled thereby easily. As a result, the temperature increase of the gas and the pressure increase in the battery 100 can be suppressed and cleavage of an unexpected part of the battery case 10 can be suppressed. Moreover, since the gas is cooled and the power of the gas is weakened, the content of the battery 100 does not easily scatter in the wide range.

Although one gas exhaust valve 13 is provided in this embodiment, two or more gas exhaust valves 13 may be provided. The area of the gas exhaust valve 13 may be determined arbitrarily. As illustrated in FIG. 2, in this embodiment, the gas exhaust valve 13 is a cross-shaped notch. However, the shape of the gas exhaust valve 13 is not limited in particular. In another embodiment, the gas exhaust valve 13 may be a linear (only longitudinal line or lateral line) notch or a notch with an X-like shape or an H-like shape, a groove with a shape of a circle, an ellipse, a square, a rhombus, a triangle, a pentagram, or the like, a combination of these, or the like. The size (length, width, or depth) of the notch or the groove is arbitrarily set and can be determined as appropriate in consideration of the pressure resistance or the like of the battery case 10, for example.

As illustrated in FIG. 2, the gas exhaust valve 13 is preferably provided at a position that overlaps with a centroid G of the lower surface 12a of the battery case 10. In other words, the gas exhaust valve 13 is preferably provided so that the centroid G of the lower surface (the surface including the gas exhaust valve 13) 12a exists in the gas exhaust valve 13 (inside the gas exhaust valve 13). Thus, the amount of gas does not easily vary in the battery case 10, and bias in the gas pressure is reduced when the gas is exhausted from the gas exhaust valve 13. Therefore, the effect of the art disclosed herein can be obtained at a higher level. Note that as illustrated in FIG. 2, when the lower surface 12a has a flat-plate and rectangular shape, an intersection of two diagonal lines expressed by virtual lines corresponds to the centroid G.

The gas exhaust valve 13 includes a center C. In FIG. 2, the center C of the gas exhaust valve 13 coincides with the centroid G of the lower surface 12a of the battery case 10. In another embodiment, however, the center C of the gas exhaust valve 13 does not need to coincide with the centroid G of the lower surface 12a. For example, the center C of the gas exhaust valve 13 may exist at a position that deviates from the centroid G of the lower surface 12a to one side in the width direction Y.

FIGS. 4A to 4C illustrate some modifications of the gas exhaust valve. In FIGS. 4A to 4C, the gas exhaust valve 13 is provided at a position that overlaps with the centroid G of the lower surface 12a of the battery case 10. In detail, a gas exhaust valve 113 illustrated in FIG. 4A has a shape including a cross-shaped notch inside a groove with an elliptical shape. In FIG. 4A, a center C of the gas exhaust valve 113 coincides with the centroid G of the lower surface 12a. A gas exhaust valve 213 illustrated in FIG. 4B has a shape including an X-shaped notch inside a groove with an elliptical shape. In FIG. 4B, a center C of the gas exhaust valve 213 exists at a position that deviates from the centroid G of the lower surface 12a to the left side in the width direction Y. A gas exhaust valve 313 illustrated in FIG. 4C has a circular groove shape. In FIG. 4C, a center C of the gas exhaust valve 313 coincides with the centroid G of the lower surface 12a.

The sealing plate 14 is a plate-shaped member that seals the opening 12h. The sealing plate 14 has an approximately rectangular shape in a plan view. The area of the sealing plate 14 is smaller than that of the long side surface 12b. The sealing plate 14 includes a liquid injection hole 15. The liquid injection hole 15 is used to inject the nonaqueous electrolyte solution into the battery case 10 after the sealing plate 14 is assembled to the case main body 12. The liquid injection hole 15 is sealed with a sealing member 16 after the nonaqueous electrolyte solution is injected. Although the liquid injection hole 15 is provided at the sealing plate 14 in this embodiment, the liquid injection hole 15 may alternatively be provided at the case main body 12 in another embodiment.

The positive electrode terminal 30 and the negative electrode terminal 40 are fixed to surfaces (specifically, a pair of sealing plates 14) of the battery case 10 facing each other here. Specifically, the positive electrode terminal 30 is attached to the sealing plate 14 that is disposed on one side in the width direction Y (right side in FIG. 1 and FIG. 2). The negative electrode terminal 40 is attached to the sealing plate 14 that is disposed on the other side in the width direction Y (left side in FIG. 1 and FIG. 2). Although the positive electrode terminal 30 and the negative electrode terminal 40 are provided at the pair of sealing plates 14 in this embodiment, the positive electrode terminal 30 and the negative electrode terminal 40 may alternatively be provided at the same sealing plate 14 or provided at the case main body 12 in another embodiment.

Each of the positive electrode terminal 30 and the negative electrode terminal 40 is exposed to an outer surface of the sealing plate 14. Here, the positive electrode terminal 30 and the negative electrode terminal 40 are disposed on an axial line extending in the width direction Y and passing a center of the sealing plate 14. However, the axial line may alternatively deviate from the center of the sealing plate 14 to, for example, the thickness direction X in another embodiment. Further alternatively, the positive electrode terminal 30 and the negative electrode terminal 40 may be disposed off the axial line. For example, one of the positive electrode terminal 30 and the negative electrode terminal 40 may deviate to one side in the thickness direction X and the other may deviate to the other side in the thickness direction X.

As illustrated in FIG. 3, the positive electrode terminal 30 is electrically connected to a positive electrode tab 23 of the multilayer electrode body 20 through a positive electrode current collecting part 32 inside the battery case 10. The positive electrode terminal 30 is preferably made of metal and more preferably made of aluminum or an aluminum alloy, for example. The negative electrode terminal 40 is electrically connected to a negative electrode tab 24 of the multilayer electrode body 20 through a negative electrode current collecting part 42 inside the battery case 10. The negative electrode terminal 40 is preferably made of metal and more preferably made of copper or a copper alloy, for example.

As illustrated in FIG. 3, the multilayer electrode body 20 is accommodated inside the battery case 10. FIG. 5 is a perspective view of the multilayer electrode body 20. As illustrated in FIG. 5, the multilayer electrode body 20 is configured so that a plurality of square positive electrodes and a plurality of square negative electrodes are stacked in the thickness direction X in an insulated state through a separator. The battery case 10 may accommodate just one multilayer electrode body 20 or a plurality of, for example two or three, multilayer electrode bodies including fewer layers than in the case of accommodating one multilayer electrode body, for example. The thickness direction X is a stacking direction in which the plurality of positive electrodes and the plurality of negative electrodes are stacked. The respective members (positive electrode, negative electrode, separator, and the like) included in the multilayer electrode body 20 may be similar to those of the general nonaqueous electrolyte secondary battery without particular limitations.

The positive electrode typically includes a positive electrode current collector, and a positive electrode active material layer fixed on at least one surface of the positive electrode current collector. The positive electrode current collector has a band shape here. The positive electrode current collector is formed of a conductive metal such as aluminum, an aluminum alloy, nickel, or stainless steel. The positive electrode current collector is a metal foil here, specifically an aluminum foil. In the positive electrode, the positive electrode tab 23 is provided. The positive electrode tab 23 is a part of the positive electrode current collector here. The positive electrode tab 23 has a convex shape here, and protrudes from the multilayer electrode body 20 to one side in the width direction Y (to the right side in FIG. 3). The positive electrode tab 23 is electrically connected to the positive electrode terminal 30 through the positive electrode current collecting part 32 here.

The positive electrode active material layer is provided to have a band shape along a longitudinal direction of the positive electrode current collector with a band shape. The positive electrode active material layer includes a positive electrode active material that is capable of reversibly storing and releasing charge carriers. As the positive electrode active material, an oxide containing at least one kind of Ni, Co, and Mn is preferable, and examples thereof include lithium-transition metal complex oxides such as lithium cobaltate, lithium manganate, lithium nickelate, a lithium-nickel-manganese complex oxide, and a lithium-nickel-cobalt complex oxide. It is preferable that the positive electrode active material include, for example, a lithium-nickel complex oxide containing Ni and Li, in which the Ni content in the complex oxide is in the range of 70 to 100 mol % relative to the total molar number of constituent elements except Li and oxygen in the complex oxide. The positive electrode active material also contains Ni, Co, and Mn a part of which is replaced by Al, Ti, Zr, P, B, Si, Nb, C, or the like or particles with a surface covered with a compound containing Al, Ti, Zr, W, P, B, Si, Nb, C, or the like. The replacement amount and the addition amount are about 0.1 to 7% in total.

The negative electrode typically includes a negative electrode current collector, and a negative electrode active material layer fixed on at least one surface of the negative electrode current collector. The negative electrode current collector has a band shape here. The negative electrode current collector is formed of a conductive metal such as copper, a copper alloy, nickel, or stainless steel. The negative electrode current collector is a metal foil here, specifically a copper foil. In the negative electrode, the negative electrode tab 24 is provided. The negative electrode tab 24 is a part of the negative electrode current collector here. The negative electrode tab 24 has a convex shape here, and protrudes from the multilayer electrode body 20 to the other side in the width direction Y (to the left side in FIG. 3). The negative electrode tab 24 is electrically connected to the negative electrode terminal 40 through the negative electrode current collecting part 42 here.

The negative electrode active material layer is provided to have a band shape along a longitudinal direction of the negative electrode current collector with a band shape. The negative electrode active material layer includes a negative electrode active material that is capable of reversibly storing and releasing the charge carriers. As the negative electrode active material, for example, a carbon material such as graphite or carbon, a metal that can store lithium, such as Si, SiO, SiC, or Sn, and a compound thereof are given.

The separator is a member that insulates between the positive electrode active material layer and the negative electrode active material layer. As the separator, for example, a porous resin sheet made of a polyolefin resin such as polyethylene (PE) or polypropylene (PP) is preferable. On a surface of the separator, a heat resistance layer (HRL) including an inorganic filler may be provided. As the inorganic filler, for example, alumina, boehmite, aluminum hydroxide, titania, or the like can be used.

As illustrated in FIG. 5, the overall shape of the multilayer electrode body 20 is approximately cuboid shape. The multilayer electrode body 20 is disposed inside the battery case 10 in such a way that the stacking direction is orthogonal to the lower surface 12a of the case main body 12 (also see FIG. 3). The multilayer electrode body 20 includes a surface (a first flat surface F1, a front surface in FIG. 5) on one side in the stacking direction (thickness direction X) and a surface (a second flat surface, a rear surface in FIG. 5 (not illustrated)) on the other side. The first flat surface F1 is a surface facing the first long side surface 12b (see FIG. 1) of the case main body 12, and the second flat surface is a surface facing the second long side surface 12b of the case main body 12.

The multilayer electrode body 20 includes four end surfaces E1 to E4 at which a multilayer structure including the plurality of positive electrodes and the plurality of negative electrodes is exposed along the stacking direction (thickness direction X). Specifically, the multilayer electrode body 20 includes the lower end surface E1 facing the lower surface 12a of the battery case 10 (specifically, the case main body 12), the upper end surface E2 facing the upper surface 12c of the battery case 10 (specifically, the case main body 12), and the right end surface E3 and the left end surface E4 facing the pair of sealing plates 14. The end surfaces E1 to E4 exist between the first flat surface F1 and the second flat surface in the stacking direction (thickness direction X). The end surfaces E1 to E4 constitute an outer periphery of the multilayer electrode body 20.

The lower end surface E1 and the upper end surface E2 extend along an XY surface of the battery case 10. The lower end surface E1 includes a part P1 facing the gas exhaust valve 13 provided at the lower surface 12a of the case main body 12. The upper end surface E2 includes a part P2 existing above the gas exhaust valve 13 in the vertical direction. The part P2 is a part overlapping with the part P1 in a plan view and existing at a surface of the multilayer electrode body 20 on a side opposite to the part P1. The right end surface E3 and the left end surface E4 extend along an XZ surface of the battery case 10. The positive electrode tab 23 with a convex shape protrudes from the right end surface E3. The negative electrode tab 24 with a convex shape protrudes from the left end surface E4.

To an outer surface of the multilayer electrode body 20, at least one tape t is attached so as to link between the first flat surface F1 (the surface facing the first long side surface 12b of the case main body 12) and the second flat surface (the surface facing the second long side surface 12b of the case main body 12). The arrangement of the tape t (for example, the width, kind, attaching position, number, and the like of the tape t) is not limited in particular as long as the effect of the art disclosed herein is not impaired remarkably. Each of the lower end surface E1 and the upper end surface E2 is preferably covered with at least one tape t at least partially. Thus, the displacement in stacking can be suppressed and the stacking structure can be stably kept easily. It is preferable that the right end surface E3 at which the positive electrode tab 23 protrudes and the left end surface E4 at which the negative electrode tab 24 protrudes be not covered with the tape t. Thus, the precipitation of metal lithium (dendrite) can be suppressed and the high charging and discharging performance can be achieved for a long time.

The tape t may be similar to any tape that has been used conventionally for this kind of application without particular limitations. The tape t preferably has higher adhesion strength and higher heat resistance. The tape t is typically formed of a plastic film of engineering plastics (such as PET, PEN, PI, or PPE), an olefin film (such as PE, OPP, or TPX), PMMA, TAC, or the like, a metal film having both surfaces or an end part covered with plastic, or the like, and has a structure in which an adhesive layer is disposed on one surface thereof. Specific examples of the tape t of the plastic film include a PTFE film tape, an acetate cloth tape, an epoxy tape, a glass cloth tape, a vinyl tape, a polyimide tape, a polyester tape, and the like. In addition, as the tape t of the metal film, for example, an aluminum foil tape, a copper foil tape, a stainless steel foil tape, or the like that is covered with a resin film is preferable over the tape whose metal part is exposed, and the metal part may contain alloy. The tape t of the metal film is excellent in heat resistance but short-circuit may occur because of the exposure of the metal part due to a notch. Therefore, in the case of using the tape t of the metal film, it is preferable that the tape t be attached and additionally, the tape of the plastic film be attached so as to cover the metal film part completely. The metal part (stainless steel foil or the like) of the tape t of the metal film preferably employs a metal whose melting point is 1000° C. or more.

In some embodiments, the tape t is preferably porous. In this case, the permeability of the nonaqueous electrolyte solution for the multilayer electrode body 20 can be improved. In the end, the battery characteristic such as rapid charging and discharging can be improved. Therefore, the effect of the art disclosed herein and the battery characteristic can be well balanced. In particular, in an aspect in which at least one of the lower end surface E1 and the upper end surface E2 is covered entirely with the tape t, the tape t is preferably porous. Although there is no particular limitation, the porosity of the tape t is preferably about less than 50%, and more preferably 20 to 40%, for example, from the viewpoint of achieving the effect of the art disclosed herein at the high level. In one example, the porosity of the tape t is preferably lower than that of the separator. Note that the porosity (%) of the tape t can be calculated from the following expression: [1−(apparent density/true density)]×100. The true density described above can be calculated based on the density and the content ratio of the constituents of the tape t. The apparent density can be calculated from the weight and volume of the tape t.

In FIG. 5, at least one tape t is attached to each of the lower end surface E1 and the upper end surface E2. Specifically, a plurality of (specifically, two) tapes t1 and t2 are attached to the lower end surface E1. The tapes t1 and t2 are attached apart from each other along the width direction Y. On the other hand, one tape t3 is attached to the upper end surface E2. The plurality of tapes t are attached asymmetrically in the up-down direction. In this embodiment, each of the lower end surface E1 and the upper end surface E2 is covered with at least one tape t asymmetrically so that gas flows toward the gas exhaust valve 13 (preferably, gas is guided toward the gas exhaust valve 13).

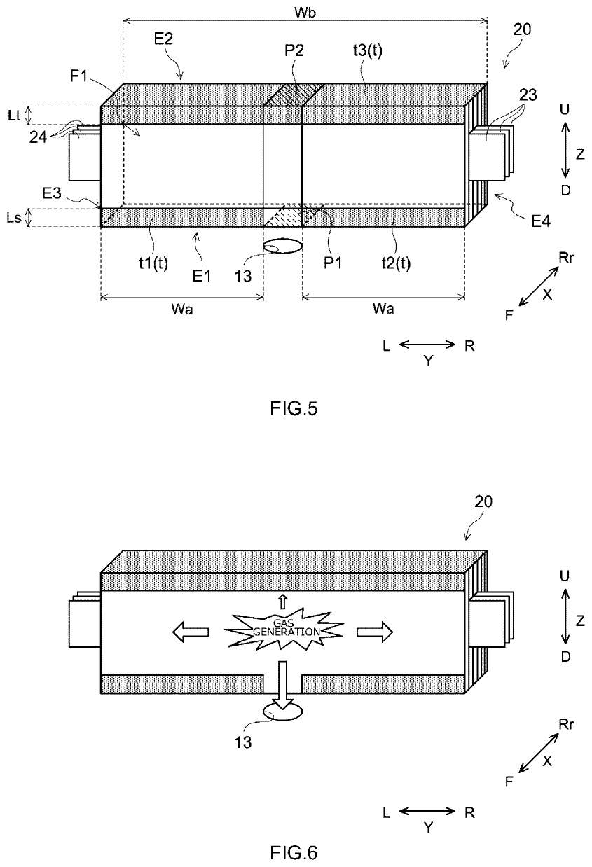

FIG. 6 is a perspective view schematically illustrating the flow of gas in the multilayer electrode body 20. Although the limited interpretation is not intended in particular, the following drawings indicate the flow of gas generated in the multilayer electrode body 20 with arrows in accordance with the result of simulation by a computer. The arrow becomes thicker as the amount of gas increases, and the thicker arrow expresses more gas. In addition, the length of the arrow is in proportion to the speed of the gas, and the longer arrow expresses faster gas flow. As illustrated in FIG. 6, in this embodiment, the flow of the gas generated in the multilayer electrode body 20 can be easily guided to the gas exhaust valve 13 while the displacement in stacking is prevented. Thus, the generated gas can be easily exhausted stably from the gas exhaust valve 13 to the outside. Therefore, the cleavage of an unexpected part of the battery case 10 can be suppressed.

In FIG. 5, the tape t3 is attached to the upper end surface E2, and a length Wb of the tape t3 in the width direction Y is longer than a length Wa of the tapes t1 and t2 attached to the lower end surface E1 (that is, Wa<Wb). In some embodiments, an area An of the upper end surface E2 that is covered with the tape t3 is preferably larger than an area Am of the lower end surface E1 that is covered with the tapes t1 and t2 (that is to say, Am<An). Thus, the gas generated in the multilayer electrode body 20 is easily guided to the gas exhaust valve 13 provided at the lower surface 12a of the case main body 12. As a result, the generated gas is easily exhausted stably from the gas exhaust valve 13 to the outside. In addition, the cleavage of an arbitrary part of the battery case 10 can be suppressed at a higher level.

In FIG. 5, the part P2 of the upper end surface E2 that exists above the gas exhaust valve 13 in the vertical direction is covered with the tape t3. In some embodiments, the part P2 of the upper end surface E2 that exists above the gas exhaust valve 13 in the vertical direction is preferably covered with the tape t. Thus, the gas generated in the multilayer electrode body 20 collides with the tape t at the part P2 and the air flow directed downward is generated easily. As a result, the generated gas is easily exhausted stably from the gas exhaust valve 13 to the outside. In addition, the cleavage of an arbitrary part of the battery case 10 can be suppressed at the higher level.

In FIG. 5, the tapes t1 and t2 at the lower end surface E1 are attached except the part P1 that faces the gas exhaust valve 13. That is to say, the part P1 that faces the gas exhaust valve 13 is not covered with the tape t. In some embodiments, the part P1 of the lower end surface E1 that faces the gas exhaust valve 13 is preferably not covered with the tape t. Thus, the gas generated in the multilayer electrode body 20 is easily exhausted from the gas exhaust valve 13 to the outside.

In FIG. 5, the entire lower end surface E1 except the part P1 that faces the gas exhaust valve 13 is covered with the tapes t1 and t2 (intentional or mechanical error and the like are allowable). The tape t3 at the upper end surface E2 is attached along the width direction Y by substantially the same length as the upper end surface E2. The upper end surface E2 is covered with the tape t3 entirely (intentional or mechanical error and the like are allowable). In some embodiments, it is preferable that the part P1 of the lower end surface E1 that faces the gas exhaust valve 13 be not covered with the tape t, and that when it is assumed that the length of the part that does not face the gas exhaust valve 13 (a non-facing part except the part P1 that faces the gas exhaust valve 13) in the width direction Y (the direction along the long side surface 12b of the battery case 10) is 100%, 10% or more of the length be covered with the tape t. Thus, the gas generated in the multilayer electrode body 20 is easily guided to the gas exhaust valve 13. Accordingly, the cleavage of an arbitrary part of the battery case 10 can be suppressed at the high level.

The length of the entire non-facing part that is covered with the tape t is more preferably 20% or more, still more preferably 50% or more, and particularly preferably 80% or more. In this case, it is preferable that the ratio of the part of the upper end surface E2 that is covered with the tape t in the width direction Y be larger than that of the part of the lower end surface E1 that does not face the gas exhaust valve 13, and more preferable that 30% or more (40% or more in particular) of the entire length in the width direction Y be covered with the tape t.

In some embodiments, the entire lower end surface E1 except the part P1 that faces the gas exhaust valve 13 is preferably covered with at least one tape t. In addition, the entire upper end surface E2 is preferably covered with at least one tape t. Thus, the gas generated in the multilayer electrode body 20 is easily guided to the gas exhaust valve 13 in particular. Accordingly, the cleavage of an arbitrary part of the battery case 10 can be suppressed at the particularly high level.

In FIG. 5, the tape t3 attached to the upper end surface E2 extends (downward) to the first flat surface F1 (the surface facing the first long side surface 12b of the case main body 12). Although the illustration is omitted, the tape t3 similarly extends to the second flat surface (the surface facing the second long side surface 12b of the case main body 12). In addition, the tapes t1 and t2 attached to the lower end surface E1 extend (upward) to the first flat surface F1 (the surface facing the first long side surface 12b of the case main body 12). Although the illustration is omitted, the tapes t1 and t2 similarly extend to the second flat surface (the surface facing the second long side surface 12b of the case main body 12). A length Lt (in the up-down direction Z) of the tape t3 attached to the upper end surface E2 that extends along the first flat surface F1 is the same (intentional or mechanical error and the like are allowable) as a length Ls (in the up-down direction Z) of the tapes t1 and t2 attached to the lower end surface E1 that extend along the first flat surface F1 here.

In some embodiments, however, the length Lt of the tape t attached to the upper end surface E2 that extends along the first flat surface F1 is preferably longer than the length Ls of the tape t attached to the lower end surface E1 that extends along the first flat surface F1 (that is to say, Ls<Lt). By making the length of the tape t on the upper end surface E2 side longer, that is, by attaching the tape t to the first flat surface F1 part at the position far from the gas exhaust valve 13, that part becomes thick. Thus, the reaction increases at the part where the tape t is attached and this part can receive high pressure. As a result, the gas generated in the multilayer electrode body 20 does not easily go up to the outside and is easily guided downward to the gas exhaust valve 13. Accordingly, the cleavage of an arbitrary part of the battery case 10 can be suppressed at the higher level. Note that in the case where the plurality of tapes t are attached to the upper end surface E2 and/or the lower end surface E1, the arithmetic average value of the lengths of the plurality of tapes t preferably satisfies the above-described value.

In FIG. 5, the tapes t1 and t2 at the lower end surface E1 are attached except the part P1 facing the gas exhaust valve 13; however, the part P1 facing the gas exhaust valve 13 may be partially or entirely covered with the tape t. In the latter case, in some embodiments, the part P1 of the lower end surface E1 that faces the gas exhaust valve 13 is preferably covered with the tape t except the part that faces a central part of the gas exhaust valve 13. In addition, a part of the upper end surface E2 that exists above the central part of the gas exhaust valve 13 in the vertical direction is preferably covered with the tape t. In this manner, the part P1 of the lower end surface E1 that faces the gas exhaust valve 13 is partially covered with the tape t, so that the gas concentrates on the part thereof that is not covered with the tape t (the part facing the central part of the gas exhaust valve 13) and the power of the gas is increased thereby, which makes it easier for the gas exhaust valve 13 to open early. Accordingly, the cleavage of an arbitrary part of the battery case 10 can be suppressed at the higher level. In this specification, “the central part of the gas exhaust valve 13” refers to the center C and its peripheral part (when the entire area of the gas exhaust valve 13 is 100, the range of the area within about 70%, preferably 30%, and more preferably 10% from the center C).

In FIG. 5, the different tapes t are attached to the lower end surface E1 and the upper end surface E2; however, one tape t may be attached to the multilayer electrode body 20. In some embodiments, the tape t is preferably wound once or more around an outer peripheral surface of the multilayer electrode body 20, except the part P1 of the lower end surface E1 that faces the gas exhaust valve 13. Thus, the entire lower end surface E1 except the part P1 that faces the gas exhaust valve 13, the entire upper end surface E2, the first flat surface F1, and the second flat surface are covered with the tape t at one time; therefore, the workability when attaching the tape t can be improved. In addition, the step difference is generated less easily at the first flat surface F1 and the second flat surface, so that the surface pressure can be homogenized. In the end, the unevenness in reaction at the charging and discharging can be suppressed.

The nonaqueous electrolyte solution is accommodated inside the battery case 10 together with the multilayer electrode body 20. The nonaqueous electrolyte solution may be similar to that in the general nonaqueous electrolyte solution secondary battery without particular limitations. The nonaqueous electrolyte solution is a nonaqueous liquid electrolyte including a nonaqueous solvent and a supporting salt. Examples of the nonaqueous solvent include carbonates such as ethylene carbonate (EC), ethyl methyl carbonate (EMC), and dimethyl carbonate (DMC). The nonaqueous solvent is preferably formed by mixing EC, EMC, and DMC each within 1 to 99% so that the total ratio becomes 100%. The supporting salt is, for example, a fluorine-containing lithium salt. The fluorine-containing lithium salt preferably contains lithium hexafluorophosphate (LiPF₆), and lithium bis(fluorosulfonyl)imide (F₂LiNO₄S₂) called LiFSI, or a mixture thereof. The concentration of the supporting salt is preferably 0.6 to 1.8 mol per liter of the nonaqueous solvent. In another embodiment, however, the nonaqueous electrolyte may have a solid form (a solid electrolyte) to be integrated with the multilayer electrode body 20.

The battery 100 can be used for various applications, and can be suitably used, for example, as a power source (drive power source) for motors mounted on vehicles such as passenger cars and trucks. The vehicle is not limited to a particular type, and may be, for example, a plug-in hybrid electric vehicle (PHEV), a hybrid electric vehicle (HEV), or a battery electric vehicle (BEV).

Several Examples relating to the present disclosure will be explained below, but the present disclosure is not meant to be limited to these Examples.

### <Construction of Battery>

First, the battery case including the gas exhaust valve was prepared in each example. The position and number of gas exhaust valves are as shown in Table 1 and FIG. 6 to FIG. 16. Note that the battery case according to each of Examples 6, 7-1, 7-2, and 8-1 includes the gas exhaust valve with the shape as illustrated in FIG. 4A (the center C of the gas exhaust valve overlaps with the centroid G of the lower surface of the battery case) and the battery case according to Example 8-2 includes the gas exhaust valve with the shape as illustrated in FIG. 4B (the center C of the gas exhaust valve is displaced from the centroid G of the lower surface of the battery case).

Next, the multilayer electrode body was prepared and the multilayer structure was fixed by attaching the tape to the outer peripheral surface of the multilayer electrode body under the conditions in Table 1. In this case, in the example in which “the presence or absence of the tape on the part facing the gas exhaust valve” is “absent” in Table 1, the tape is not attached to the part of the lower end surface that faces the gas exhaust valve. In addition, in the example in which “the presence or absence of the tape on the part above the gas exhaust valve in the vertical direction” is “present” in Table 1, the tape is attached to the part of the upper end surface that exists above the gas exhaust valve in the vertical direction so that this part is covered with the tape. FIG. 6 to FIG. 16 express the positional relation between the gas exhaust valve and the tape in each example. Then, the multilayer electrode body was accommodated in the battery case, and the nonaqueous electrolyte solution was injected into the battery case; thus, the square battery as illustrated in FIG. 3 was manufactured as a sample.

### <Evaluation of Battery>

While the battery manufactured as a sample was discharged, the battery was held between metal blocks made of aluminum with a thickness of 3 cm through a heat insulating material or an elastic body from the long side surfaces on both sides, and restrained with a constant pressure of 0.1 to 1 MPa. Note that a hole of Φ several millimeters through which a needle can be inserted exists at a center of the metal block (at a position of a centroid (center) of the long side surface of the battery). This hole has a hole diameter of about +1 to 2 mm relative to the diameter of the needle. For example, when the needle has a diameter of 3 mm, the hole diameter is about 3.1 to 3.2 mm. Next, the battery held between the metal blocks was charged fully (SOC 100%). Then, a needle penetration test was performed in accordance with the following procedure.

In the needle penetration test, a predetermined needle was penetrated through the hole at the center of the metal block to forcibly short-circuit the battery and the temperature of the battery was increased. Note that the test temperature was room temperature (about 25° C.). As the needle, a round nail SIZE: N65 (ϕ3 mm, the shape is selected without angle regulation) manufactured by DAIDOHANT. CO., LTD. was used. The needle was penetrated at a speed of 1 mm/s and the needle penetration was stopped when the thermal runway of the battery occurred.

Then, the mode change of the battery after the thermal runaway was evaluated based on seven ranks, from Rank 1 to Rank 7. The mode change of the battery at each rank is as follows. The results are shown in Table 1.

Rank 1: the battery case did not change except that the gas exhaust valve was opened.
Rank 2: the gas exhaust valve was opened and only its periphery was cleaved, and other than these, the battery case did not change.
Rank 3: the gas exhaust valve was opened, and three or less cleavages occurred in its periphery and the battery case but no cleavage occurred at both terminal parts.
Rank 4: the gas exhaust valve was opened, and four to nine cleavages occurred in its periphery and the battery case but no cleavage occurred at both terminal parts.
Rank 5: the gas exhaust valve was opened, ten or more cleavages occurred in its periphery and the battery case, and moreover, the cleavage also occurred at both terminal parts.
Rank 6: the gas exhaust valve was opened, ten or more cleavages occurred in its periphery and the battery case, the cleavage also occurred at both terminal parts, and a surface of one terminal part is separated from the battery case.
Rank 7: the gas exhaust valve was opened, ten or more cleavages occurred in its periphery and the battery case, the cleavage also occurred at both terminal parts, a surface of one terminal part is separated from the battery case, and 70 wt % or more of the contents scattered out of the battery case (Comparative Example).

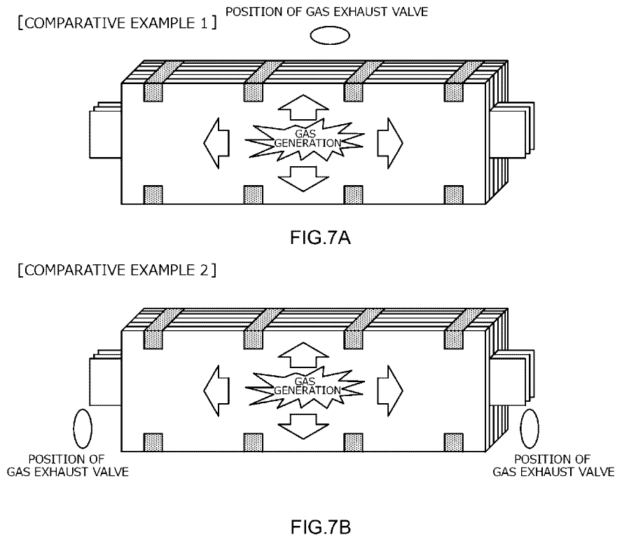

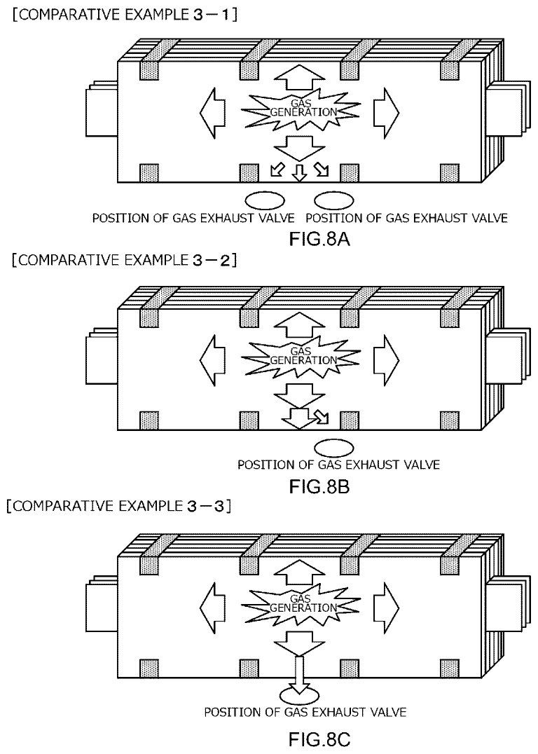

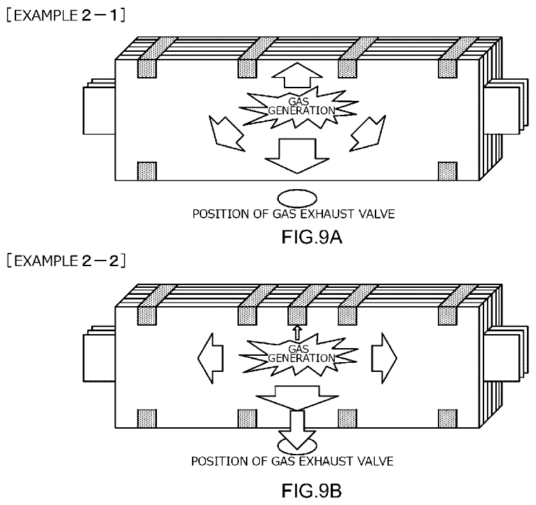

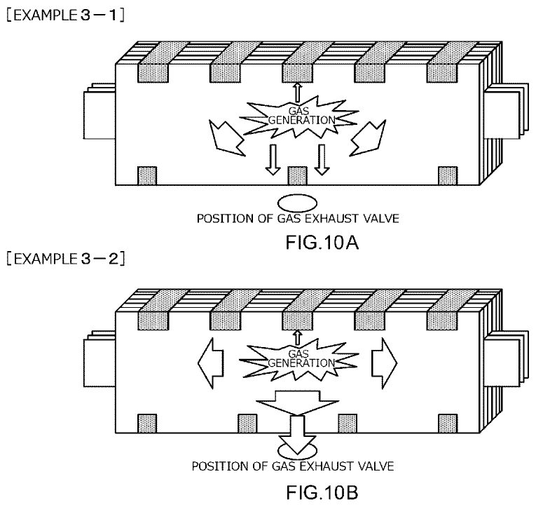

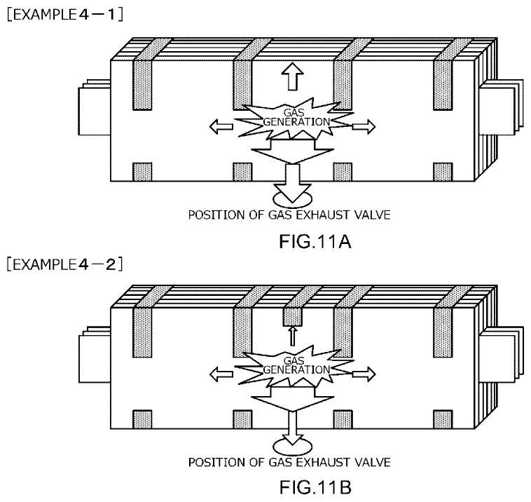

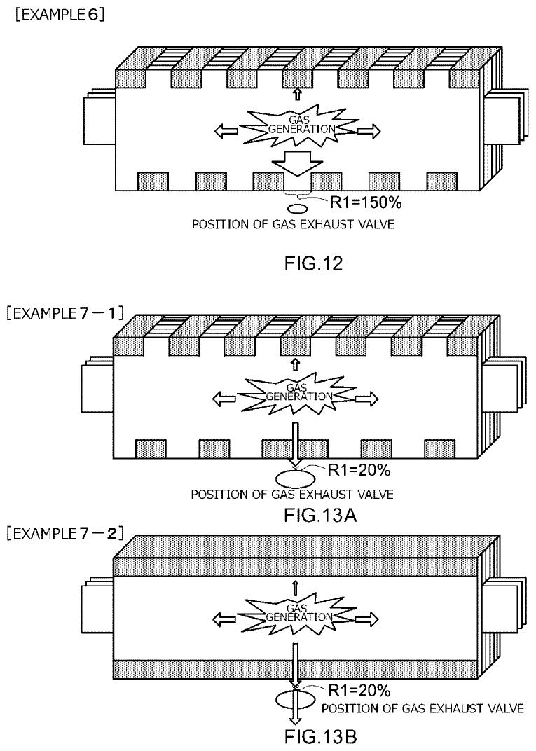

TABLE 1

| | | Gas exhaust valve | | | | | | |
|---|---|---|---|---|---|---|---|---|
| | | | | Centroid of | Aspect of attaching tape to upper | | | |
| | | | | lower surface | end surface and lower end surface | | | |
| | | Position | Number | within gas | | Magnitude | Magnitude | Magnitude |
| | | of gas | of gas | exhaust valve | | relation of | relation of | relation of |
| | Reference | exhaust | exhaust | Present/ | Vertical | Wa and Wb | Am and An | Ls and Lt |
| | drawing | valve | valves | Absent | symmetry | (*1) | (*2) | (*3) |
| Comparative | FIG. 7 | Upper | 1 | — | Symmetry | Wa = Wb | Am = An | Ls = Lt |
| Example 1 | | surface | | | | | | |
| Comparative | | Side | 2 | — | Symmetry | Wa = Wb | Am = An | Ls = Lt |
| Example 2 | | surface | | | | | | |
| Comparative | FIG. 8 | Lower | 2 | Absent | Symmetry | Wa = Wb | Am = An | Ls = Lt |
| Example 3-1 | | surface | | | | | | |
| Comparative | | Lower | 1 | Absent | Symmetry | Wa = Wb | Am = An | Ls = Lt |
| Example 3-2 | | surface | | | | | | |
| Comparative | | Lower | 1 | Present | Symmetry | Wa = Wb | Am = An | Ls = Lt |
| Example 3-3 | | surface | | | | | | |
| Example 2-1 | FIG. 9 | Lower | 1 | Present | Asymmetry | Wa = Wb | Am < An | Ls = Lt |
| | | surface | | | | | | |
| Example 2-2 | | Lower | 1 | Present | Asymmetry | Wa = Wb | Am < An | Ls = Lt |
| | | surface | | | | | | |
| Example 3-1 | FIG. 10 | Lower | 1 | Present | Asymmetry | Wa < Wb | Am < An | Ls = Lt |
| | | surface | | | | | | |
| Example 3-2 | | Lower | 1 | Present | Asymmetry | Wa < Wb | Am < An | Ls = Lt |
| | | surface | | | | | | |
| Example 4-1 | FIG. 11 | Lower | 1 | Present | Asymmetry | Wa = Wb | Am < An | Ls < Lt |
| | | surface | | | | | | |
| Example 4-2 | | Lower | 1 | Present | Asymmetry | Wa = Wb | Am < An | Ls < Lt |
| | | surface | | | | | | |
| Example 5 | FIG. 6 | Lower | 1 | Present | Asymmetry | Wa = Wb | Am < An | Ls = Lt |
| | | surface | | | | | | |
| Example 6 | FIG. 12 | Lower | 1 | Present | Asymmetry | Wa = Wb, | Am < An | Ls = Lt |
| | | surface | | | | Partially | | |
| | | | | | | Wa < Wb | | |

| | | | Upper end | | | | | |
|---|---|---|---|---|---|---|---|---|
| | | | surface | | | | | |
| | Lower end | | Tape above | | Upper end | | | |
| | surface | | gas exhaust | | surface | | | Evaluation |
| | Tape in part | | valve in | | Tape | | | result |
| | facing gas | Lower end | vertical | Lower end | coverage | | Tape | Mode |
| | exhaust valve | surface | direction | surface | at upper | | coverage | change of |
| | Present/ | R1/% | Present/ | R2/% | end | Tape | side | cell after |
| | Absent | (*4) | Absent | (*5) | surface/% | porosity/% | surface/% | test |
| Comparative | Absent | 100 | Absent | 22 | 21 | 0 | 7 | Rank 7 |
| Example 1 | | | | | | | | |
| Comparative | Absent | 100 | Absent | 22 | 21 | 0 | 7 | Rank 7 |
| Example 2 | | | | | | | | |
| Comparative | Absent | 100 | Absent | 22 | 21 | 0 | 7 | Rank 6 |
| Example 3-1 | | | | | | | | |
| Comparative | Absent | 100 | Absent | 22 | 21 | 0 | 7 | Rank 6 |
| Example 3-2 | | | | | | | | |
| Comparative | Absent | 100 | Absent | 22 | 21 | 0 | 7 | Rank 5 |
| Example 3-3 | | | | | | | | |
| Example 2-1 | Absent | 100 | Absent | 11 | 21 | 0 | 5 | Rank 4 |
| Example 2-2 | Absent | 100 | Present | 22 | 26 | 0 | 8 | Rank 3 |
| Example 3-1 | Present | 0 | Present | 17 | 43 | 0 | 10 | Rank 4 |
| Example 3-2 | Absent | 100 | Present | 23 | 43 | 0 | 11 | Rank 3 |
| Example 4-1 | Absent | 100 | Absent | 24 | 23 | 0 | 10 | Rank 4 |
| Example 4-2 | Absent | 100 | Present | 24 | 28 | 0 | 11 | Rank 3 |
| Example 5 | Absent | 100 | Present | 100 | 100 | 0 | 32 | Rank 1 |
| Example 6 | Absent | 150 | Present | 55 | 60 | 0 | 18 | Rank 4 |

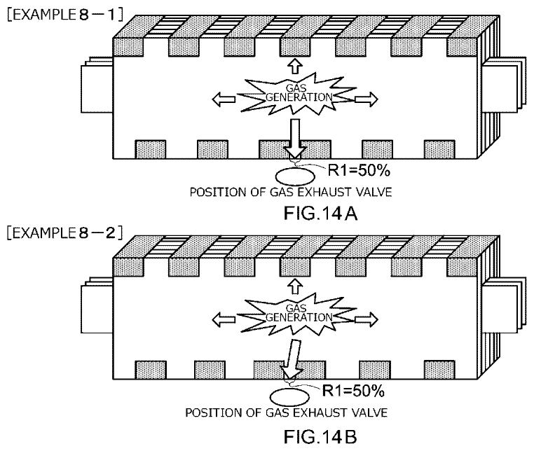

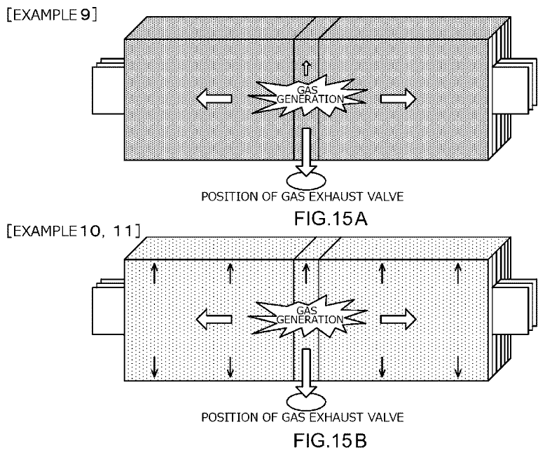

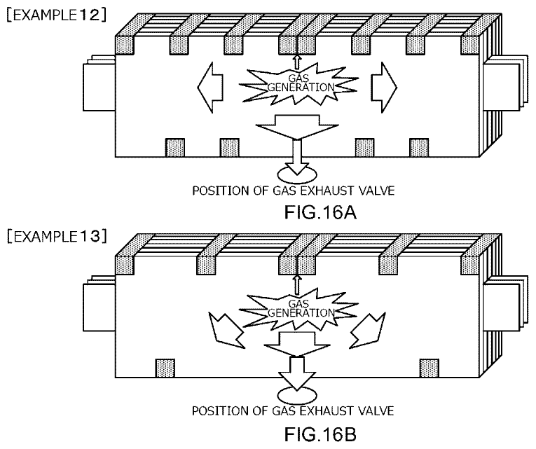

TABLE 1

| | | Gas exhaust valve | | | | | | |
|---|---|---|---|---|---|---|---|---|
| | | | | Centroid of | | | | |
| | | | | lower surface | Aspect of attaching tape to upper | | | |
| | | | | within gas | end surface and lower end surface | | | |
| | | Position | Number | exhaust | | Magnitude | Magnitude | Magnitude |
| | | of gas | of gas | valve | | relation of | relation of | relation of |
| | Reference | exhaust | exhaust | Present/ | Vertical | Wa and Wb | Am and An | Ls and Lt |
| | drawing | valve | valves | Absent | symmetry | (*1) | (*2) | (*3) |
| Example 7-1 | FIG. 13 | Lower | 1 | Present | Asymmetry | Wa = Wb | Am < An | Ls = Lt |
| | | surface | | | | | | |
| Example 7-2 | | Lower | 1 | Present | Asymmetry | Wa < Wb | Am < An | Ls = Lt |
| | | surface | | | | | | |
| Example 8-1 | FIG. 14 | Lower | 1 | Present | Asymmetry | Wa = Wb | Am < An | Ls = Lt |
| | | surface | | | | | | |
| Example 8-2 | | Lower | 1 | Present | Asymmetry | Wa = Wb | Am < An | Ls = Lt |
| | | surface | | | | | | |
| Example 9 | FIG. 15 | Lower | 1 | Present | Asymmetry | Wa < Wb | Am < An | — |
| | | surface | | | | | | |
| Example 10 | | Lower | 1 | Present | Asymmetry | — | Am < An | — |
| | | surface | | | | | | |
| Example 11 | | Lower | 1 | Present | Asymmetry | — | Am < An | — |
| | | surface | | | | | | |
| Example 12 | FIG. 16 | Lower | 1 | Present | Asymmetry | Wa = Wb | Am < An | Ls = Lt |
| | | surface | | | | | | |
| Example 13 | | Lower | 1 | Present | Asymmetry | Wa = Wb | Am < An | Ls = Lt |
| | | surface | | | | | | |

| | | | Upper end | | | | | |
|---|---|---|---|---|---|---|---|---|
| | | | surface | | | | | |
| | Lower end | | Tape above | | Upper end | | | |
| | surface | | gas exhaust | | surface | | | Evaluation |
| | Tape in part | | valve in | | Tape | | Tape | result |
| | facing gas | Lower end | vertical | Lower end | coverage | | coverage | Mode |
| | exhaust valve | surface | direction | surface | at upper | | at long | change of |
| | Present/ | R1/% | Present/ | R2/% | end | Tape | side | cell after |
| | Absent | (*4) | Absent | (*5) | surface/% | porosity/% | surface/% | test |
| Example 7-1 | Present | 20 | Present | 51 | 60 | 0 | 18 | Rank 2 |
| Example 7-2 | Absent | 20 | Present | 100 | 100 | 0 | 33 | Rank 1 |
| Example 8-1 | Present | 50 | Present | 53 | 60 | 0 | 18 | Rank 3 |
| Example 8-2 | Present | 50 | Present | 53 | 60 | 0 | 18 | Rank 3 |
| Example 9 | Absent | 100 | Present | 100 | 100 | 0 | 100 | Rank 1 |
| Example 10 | Absent | 100 | Present | 100 | 100 | 20 | 100 | Rank 2 |
| Example 11 | Absent | 100 | Present | 100 | 100 | 40 | 100 | Rank 3 |
| Example 12 | Absent | 100 | Present | 23 | 43 | 0 | 9 | Rank 2 |
| Example 13 | Absent | 100 | Present | 11 | 32 | 0 | 6 | Rank 3 |

*1: Wa represents the width in the long side direction of the tape attached to the lower end surface, and Wb represents the width in the long side direction of the tape attached to the upper end surface.
*2: Am represents the area of the lower end surface that is covered with the tape, and An represents the area of the upper end surface that is covered with the tape.
*3: Ls represents the length of the tape attached on the long side surface side from the lower end surface along the stacking direction, and Lt represents the length of the tape attached on the long side surface side from the upper end surface along the stacking direction.
*4: R1 represents the ratio of the length of the part without the tape to the length from the center C to the outer edge of the gas exhaust valve.
*5: R2 represents the tape coverage of the part of the lower end surface other than the part facing the gas exhaust valve (non-facing part).

First, Comparative Examples 1 and 2 and Comparative Examples 3-1 to 3-3 in Table 1 are compared. In Comparative Example 1, the gas exhaust valve is provided at the upper surface of the battery case. In Comparative Example 2, the gas exhaust valve is provided at each of both side surfaces (specifically, a pair of sealing plates) of the battery case. In Comparative Examples 1 and 2, the mode change of the battery after the thermal runaway was the largest and the state of Rank 7 (lowest rank) was exhibited (also see the gas flow (arrows) in FIG. 7A and FIG. 7B). Although it is not intended to limit the interpretation in particular, the reason is considered as follows. In the case where the gas exhaust valve is provided at the upper surface or the side surface of the battery case, the gas generated at the thermal runaway is not cooled easily and the gas temperature and/or the gas pressure remains high; thus, the battery case is cleaved or the content scatters to the outside.

In Comparative Examples 3-1 to 3-3, the gas exhaust valve was provided at the lower surface of the battery case. In Comparative Examples 3-1 to 3-3, the mode change of the battery after the thermal runaway was suppressed relatively compared to that in Comparative Examples 1 and 2 and the states of Ranks 5 to 6 were exhibited (also see the gas flow (arrows) in FIG. 8A to FIG. 8C). Although it is not intended to limit the interpretation in particular, the reason is considered as follows: the gas generated at the thermal runaway is cooled due to the contact with the lower surface of the battery case and the increase in gas temperature or gas pressure is suppressed. However, the cleavage was recognized also in both terminal parts; therefore, it was impossible to say that the effect of the art disclosed herein was enough.

In Comparative Examples 3-1 and 3-2, the gas exhaust valve does not overlap with the centroid G of the lower surface of the battery case. In Comparative Example 3-3, the gas exhaust valve overlaps with the centroid G of the lower surface of the battery case. Among Comparative Examples 3-1 to 3-3, the mode change of the battery after the thermal runaway was suppressed the most in Comparative Example 3-3. Although it is not intended to limit the interpretation in particular, the reasons are considered as follows. In Comparative Examples 3-1 and 3-2, the amount of gas becomes inhomogeneous within the battery and due to the bias in gas pressure, a part of the battery case other than the gas exhaust valve, in particular, in the case of two valves, the space between the valves and in the case of one valve, the periphery of the valve, is easily cleaved and this triggers the cleavage at each part of the battery case. On the other hand, in Comparative Example 3, the inhomogeneity in the amount of gas within the battery occurred less easily and the bias in gas pressure was small; therefore, it is considered that the cleavage did not occur easily at the place other than the gas exhaust valve of the battery case.

Next, Examples 2-1 and 2-2 and Comparative Example 3-3 in Table 1 are compared. Example 2-1 is similar to Comparative Example 3-3 except that the tapes are attached to the lower end surface E1 and the upper end surface E2 asymmetrically in the up-down direction. In Example 2-1, the mode change of the battery after the thermal runaway was further suppressed compared to that in Comparative Example 3-3 and the state of Rank 4 was exhibited (also see the gas flow (arrows) in FIG. 9A). In addition, Example 2-2 is similar to Example 2-1 except that the part of the upper end surface that exists above the gas exhaust valve in the vertical direction is covered with the tape. In Example 2-2, the mode change of the battery after the thermal runaway was further suppressed compared to that in Example 2-1 and the state of Rank 3 was exhibited (also see the gas flow (arrows) in FIG. 9B). Although it is not intended to limit the interpretation in particular, the reason is considered as follows: the generated gas collides with the tape above the gas exhaust valve in the vertical direction and flows easily downward.

Next, Examples 3-1 and 3-2 in Table 1 are compared. In each of Examples 3-1 and 3-2, the wider tapes than those in Examples 2-1 and 2-2 are attached to the upper end surface and the width of the tape attached to the upper end surface is larger than that of the tape attached to the lower end surface. While the part facing the gas exhaust valve is not covered with the tape in Example 3-1, the part facing the gas exhaust valve is covered with the tape in Example 3-2. In Example 3-2, the mode change of the battery after the thermal runaway was suppressed relatively compared to that in Example 3-1 and the state of Rank 3 was exhibited (also see the gas flow (arrows) in FIG. 10A and FIG. 10B).

Next, Examples 4-1 and 4-2 in Table 1 are compared. In each of Examples 4-1 and 4-2, the tape attached to the upper end surface is longer in the stacking direction than that in Examples 2-1 and 2-2. In Example 4-2, the mode change of the battery after the thermal runaway was suppressed relatively compared to that in Example 4-1 and the state of Rank 3 was exhibited (also see the gas flow (arrows) in FIG. 11A and FIG. 11B). Although it is not intended to limit the interpretation in particular, the reason is considered as follows: the generated gas collides with the tape above the gas exhaust valve in the vertical direction and flows easily downward.

Next, in Example 5 in Table 1, the entire lower end surface except the part thereof that faces the gas exhaust valve is covered with the tape and the entire upper end surface is covered with the tape. In Example 5, the mode change of the battery after the thermal runaway was suppressed at the particularly high level compared to those in the other Examples and the excellent result (Rank 1) was exhibited (also see the gas flow (arrows) in FIG. 6).

Next, Examples 6 to 8-2 in Table 1 are compared. R1 (a ratio of the length of the part where the tape is not attached, to the length from the center C of the gas exhaust valve to an outer edge) is 150% in Example 6, 20% in Examples 7-1 and 7-2, and 50% in Examples 8-1 and 8-2. In Examples 7-1 and 7-2, the mode change of the battery after the thermal runaway was suppressed relatively compared to that in Examples 6, 8-1, and 8-2 and the state of Rank 1 or 2 was exhibited (also see the gas flow (arrows) in FIG. 12, FIGS. 13A and 13B, and FIGS. 14A and 14B). Although it is not intended to limit the interpretation in particular, the reason is considered as follows: as R1 is smaller, the gas concentrates on the part that is not covered with the tape to energize the jetting gas, making it possible to open the gas exhaust valve early.

In addition, Example 7-2 is similar to Example 7-1 except that the lower end surface and the upper end surface are covered with the tapes more widely. In Example 7-2, the mode change of the battery after the thermal runaway was suppressed at the particularly high level compared to that in Example 7-1 and the excellent result (Rank 1) was exhibited. Although it is not intended to limit the interpretation in particular, the reason is considered as follows: the generated gas collides with the gas exhaust valve with higher power to increase the pressure at and around the gas exhaust valve rapidly, making it possible to open the gas exhaust valve early.

In addition, Example 8-2 is similar to Example 8-1 except that the center C of the gas exhaust valve deviates from the centroid G of the lower surface of the battery case. In Example 8-2, the mode change of the battery after the thermal runaway was in the same rank (Rank 3) as that in Example 8-1; therefore, it is understood that even if the center C of the gas exhaust valve does not coincide with the centroid G of the lower surface of the battery case, the equivalent effect can be obtained as long as the gas exhaust valve is provided at the position overlapping with the centroid G of the lower surface of the battery case.

Next, Examples 9 to 11 and Example 5 in Table 1 are compared. In Example 9, the tape is wound once or more around the electrode body. In Example 9, the mode change of the battery after the thermal runaway is in the same rank (Rank 1) as that in Example 5; therefore, it is understood that the equivalent effect can be obtained from one tape, as long as the entire lower end surface except the part thereof that faces the gas exhaust valve is covered with the tape and the entire upper end surface is covered with the tape (also see the gas flow (arrows) in FIG. 15A). The comparison among Example 9 (porosity 0%), Example 10 (porosity 20%), and Example 11 (porosity 40%) with the different tape porosities indicates that as the tape porosity is lower, the mode change of the battery after the thermal runaway was suppressed at the higher level (also see the gas flow (arrows) in FIGS. 15B and 15C). The reason is considered as follows: when the tape has pores, the gas leaks from those pores and the gas is less guided in the direction to the gas exhaust valve.

Next, Examples 12 and 13, and Example 2-2 in Table 1 are compared. In Example 12, the tape coverage (43%) at the upper end surface is larger than that (26%) in Example 2-2. The comparison between Example 12 and Example 2-2 indicates that as the tape coverage at the upper end surface was higher, the mode change of the battery after the thermal runaway was suppressed at the higher level (also see the gas flow (arrows) in FIG. 16A). In Example 13, the tape coverage (11%) of the part of the lower end surface that does not face the gas exhaust valve (non-facing part) is lower than that (22%) in Example 2-2. In Example 13, the mode change of the battery after the thermal runaway is in the same rank (Rank 3) as that in Example 2-2; therefore, it is understood that the equivalent effect can be obtained as long as the tape coverage of the non-facing part is 10% or more (also see the gas flow (arrows) in FIG. 16B).

The embodiments of the art disclosed herein has been described above; however, these are just examples and will not limit the scope of claims. The art described in the scope of claims includes those in which the specific examples given above are variously modified and changed.

As described above, the following items are given as specific aspects of the art disclosed herein.

Item 1: The nonaqueous electrolyte secondary battery including the multilayer electrode body that includes the plurality of positive electrodes and the plurality of negative electrodes, the nonaqueous electrolyte, and the battery case that accommodates the multilayer electrode body and the nonaqueous electrolyte, in which the battery case includes at least the lower surface, the pair of side surfaces extending from the pair of edges of the lower surface and facing each other, and the upper surface facing the lower surface, the gas exhaust valve is provided at the lower surface, the multilayer electrode body includes the pair of flat surfaces facing the pair of side surfaces of the battery case, and the lower end surface facing the lower surface of the battery case and the upper end surface facing the upper surface of the battery case, the lower end surface and the upper end surface being the end surfaces where the multilayer structure of the positive electrodes and the negative electrodes is exposed, at least one tape is attached to the multilayer electrode body so as to link between the pair of flat surfaces, and the lower end surface and the upper end surface of the multilayer electrode body are covered with the tape asymmetrically so that the gas flows toward the gas exhaust valve.
Item 2: The nonaqueous electrolyte secondary battery according to Item 1, in which the gas exhaust valve is provided at the position overlapping with the centroid of the lower surface of the battery case.
Item 3: The nonaqueous electrolyte secondary battery according to Item 1 or 2, in which the area of the upper end surface that is covered with the tape is larger than the area of the lower end surface that is covered with the tape.
Item 4: The nonaqueous electrolyte secondary battery according to any one of Items 1 to 3, in which the part of the upper end surface that exists above the gas exhaust valve in the vertical direction is covered with the tape.
Item 5: The nonaqueous electrolyte secondary battery according to any one of Items 1 to 4, in which at least one tape is attached to each of the upper end surface and the lower end surface, and the tape attached to the upper end surface is longer along the flat surface of the multilayer electrode body than the tape attached to the lower end surface.
Item 6: The nonaqueous electrolyte secondary battery according to any one of Items 1 to 5, in which the entire lower end surface except the part thereof that faces the gas exhaust valve is covered with the tape, and the entire upper end surface is covered with the tape.
Item 7: The nonaqueous electrolyte secondary battery according to any one of Items 1 to 5, in which the part of the lower end surface that faces the gas exhaust valve is covered with the tape except the part thereof that faces the central part of the gas exhaust valve, and the part of the upper end surface that exists above the central part of the gas exhaust valve in the vertical direction is covered with the tape.
Item 8: The nonaqueous electrolyte secondary battery according to any one of Items 1 to 5, in which the tape is wound once or more around the outer peripheral surface of the multilayer electrode body except the part of the lower end surface that faces the gas exhaust valve.
Item 9: The nonaqueous electrolyte secondary battery according to any one of Items 1 to 8, in which the tape is porous.
Item 10: The nonaqueous electrolyte secondary battery according to any one of Items 1 to 5, in which the part of the lower end surface that faces the gas exhaust valve is not covered with the tape, and when the length of the part of the lower end surface that does not face the gas exhaust valve in the direction along the side surface of the battery case is 100%, 10% or more of the length is covered with the tape.

### REFERENCE SIGNS LIST

10 Battery case
12 Case main body
12a Lower surface
12b Long side surface
13, 113, 213, 313 Gas exhaust valve
14 Sealing plate
20 Multilayer electrode body
E1 Lower end surface
E2 Upper end surface
F1 First flat surface
P1 Part facing gas exhaust valve
t Tape
100 Battery (nonaqueous electrolyte secondary battery)

What is claimed is:

1. A nonaqueous electrolyte secondary battery comprising a multilayer electrode body that includes a plurality of positive electrodes and a plurality of negative electrodes, a nonaqueous electrolyte, and a battery case that accommodates the multilayer electrode body and the nonaqueous electrolyte, wherein
the battery case includes at least a lower surface, a pair of side surfaces extending from a pair of edges of the lower surface and facing each other, and an upper surface facing the lower surface,
a gas exhaust valve is provided at the lower surface,
the multilayer electrode body includes a pair of flat surfaces facing the pair of side surfaces of the battery case, and a lower end surface facing the lower surface of the battery case and an upper end surface facing the upper surface of the battery case, the lower end surface and the upper end surface being end surfaces where a multilayer structure of the positive electrodes and the negative electrodes is exposed,
at least one tape is attached to the multilayer electrode body so as to link between the pair of flat surfaces, and
the lower end surface and the upper end surface of the multilayer electrode body are covered with the tape asymmetrically so that gas flows toward the gas exhaust valve.

2. The nonaqueous electrolyte secondary battery according to claim 1, wherein the gas exhaust valve is provided at a position overlapping with a centroid of the lower surface of the battery case.

3. The nonaqueous electrolyte secondary battery according to claim 1, wherein an area of the upper end surface that is covered with the tape is larger than an area of the lower end surface that is covered with the tape.

4. The nonaqueous electrolyte secondary battery according to claim 1, wherein a part of the upper end surface that exists above the gas exhaust valve in a vertical direction is covered with the tape.

5. The nonaqueous electrolyte secondary battery according to claim 1, wherein
at least one tape is attached to each of the upper end surface and the lower end surface, and
the tape attached to the upper end surface is longer along the flat surface of the multilayer electrode body than the tape attached to the lower end surface.

6. The nonaqueous electrolyte secondary battery according to claim 1, wherein
the entire lower end surface except a part thereof that faces the gas exhaust valve is covered with the tape, and
the entire upper end surface is covered with the tape.

7. The nonaqueous electrolyte secondary battery according to claim 1, wherein
a part of the lower end surface that faces the gas exhaust valve is covered with the tape except a part thereof that faces a central part of the gas exhaust valve, and
a part of the upper end surface that exists above the central part of the gas exhaust valve in a vertical direction is covered with the tape.

8. The nonaqueous electrolyte secondary battery according to claim 1, wherein the tape is wound once or more around an outer peripheral surface of the multilayer electrode body except a part of the lower end surface that faces the gas exhaust valve.

9. The nonaqueous electrolyte secondary battery according to claim 8, wherein the tape is porous.

10. The nonaqueous electrolyte secondary battery according to claim 3, wherein a part of the lower end surface that faces the gas exhaust valve is not covered with the tape, and when a length of a part of the lower end surface that does not face the gas exhaust valve in a direction along the side surface of the battery case is 100%, 10% or more of the length is covered with the tape.
